(19) United States
(12) Patent Application Publication
(10) Pub. No.: US 2026/0004329 A1
(43) Pub. Date: Jan. 1, 2026

(54) LANGUAGE MODEL-BASED METHOD AND SYSTEM FOR EXTRACTING PRODUCT REVIEW KEYWORD

(71) Applicant: NAVER CORPORATION, Seongnam-si (KR)

(72) Inventors: Jaewook KANG, Seongnam-si (KR); Bokyung SON, Seongnam-si (KR); Dongju PARK, Seongnam-si (KR); Seong Jae CHOI, Seongnam-si (KR); Hae Na KWON, Seongnam-si (KR); Boyoun PARK, Seongnam-si (KR); Sooyoung KIM, Seongnam-si (KR); Dong Wook PARK, Seongnam-si (KR)

(21) Appl. No.: 19/319,129

(22) Filed: Sep. 4, 2025

Related U.S. Application Data
(63) Continuation of application No. PCT/KR2024/002603, filed on Feb. 28, 2024.

(30) Foreign Application Priority Data
Mar. 8, 2023 (KR) 10-2023-0030561

(51) Int. Cl. G06Q 30/0282; G06N 20/00

(52) U.S. Cl. CPC G06Q 30/0282; G06N 20/00

(57) ABSTRACT

A language model-based method for extracting a product review keyword includes collecting, on the basis of information for specifying a product, review data associated with the product; using a language model so as to generate, on the basis of a plurality of predetermined questions, at least one piece of response data from at least some pieces of the review data; and extracting, on the basis of the at least one piece of response data, a review keyword associated with the product.

### CROSS-REFERENCE TO RELATED APPLICATIONS

This is a continuation application of International Application No. PCT/KR2024/002603, filed Feb. 28, 2024, which claims the benefit of Korean Patent Application No. 10-2023-0030561, filed Mar. 8, 2023.

### BACKGROUND OF THE INVENTION

### Field of the Invention

The present disclosure relates to a method and a system for extracting a product review keyword, and more specifically, to a method and a system for generating response data based on a plurality of predetermined questions from review data associated with a product by using a language model, and extracting a keyword based on the response data.

### Description of Related Art

Recently, as transactions of products online have increased, types of products transacted online are becoming diversified. Accordingly, a prospective purchaser often refers to reviews of other purchasers before purchasing the corresponding product. When reviews of the corresponding product are not present, the prospective purchaser may not easily purchase the product even though the price thereof is cheaper than that of a similar product. As such, when purchasing the product online, reviews of the product have a significant influence on a purchase determination.

Purchasers may encounter reviews of the product through blogs, internet cafes, or product review comments in online shopping malls (or smart stores). However, not all product reviews have high reliability, and reviews that exaggerate advantages of the product or promotional reviews for purposes of product advertisement are also posted online. In addition, as the amount of product reviews searchable online increases, a seller or a prospective purchaser may spend a great deal time and effort to search product information suitable for their own needs.

### BRIEF SUMMARY OF THE INVENTION

The present disclosure describes a language model-based method and a system (device) for extracting a product review keyword to solve the above-described problems.

The present invention may be implemented in various ways including a method, a device (system), or a computer program stored in a computer-readable storage medium.

According to an embodiment of the present invention, there is provided a method of extracting a product review keyword based on a language model, performed by at least one processor, the method may include: collecting review data associated with a product based on information for specifying the product; generating at least one piece of response data from at least a part of the review data based on a plurality of predetermined questions using a language model; and extracting a review keyword associated with the product based on the at least one piece of response data.

There may be provided a non-transitory computer-readable recording medium storing instructions for executing on a computer a method of extracting a product review keyword according to an embodiment of the present invention.

There is provided a system, according to an embodiment of the present invention. The system may include: a communication module; a memory; and at least one processor connected to the memory and configured to execute at least one computer-readable program included in the memory. The program may include instructions for collecting review data associated with a product based on information for specifying the product; generating at least one piece of response data from at least a part of the review data based on a plurality of predetermined questions using a language model; and extracting a review keyword associated with the product based on the at least one piece of response data.

According to various embodiments of the present invention, a user may easily identify a review keyword of a product only by inputting information for specifying the product. Accordingly, the user may easily understand and analyze information or characteristics of an associated brand or product, based on product reviews of other users who have purchased or used the product. In addition, by providing a review keyword, it may help the user to determine whether to purchase the product.

According to various embodiments of the present invention, by removing spam/promotional review data from review data using a passage-type classifier, the property of the review data may be simplified when extracting the review keyword. That is, only informative review data may be extracted from the review data, and used in a subsequent review keyword extracting step. Accordingly, uncertainty of the review keyword extracted in the review keyword extracting step may be reduced, so that the reliability of the review keyword may be improved.

According to various embodiments of the present invention, whether a response corresponding to at least a part of a plurality of predetermined question data is included in the review data may be identified. That is, the characteristic of information included in the review data may be identified in advance. Accordingly, uncertainty in the review keyword extracting step may be reduced, thereby improving the reliability of the review keyword.

According to various embodiments of the present invention, in addition to a generative model that extracts response data corresponding to question data from the review data, by using an additional generative model, the quality of the output response data may be improved. In addition, by training the additional generative model by examining only a part of the response data extracted by the generative model, without examining all the response data, an examination efficiency of the response data may be improved.

According to various embodiments of the present invention, by postprocessing the response data extracted from the review data in response to the question data, the accuracy or the reliability of the review keyword extracted therefrom may be improved. In addition, by reflecting at least a part of the sentence of original review data in the review keyword, the reliability of the finally extracted review keyword may be improved.

According to various embodiments of the present invention, a user may easily identify a review keyword associated with the corresponding product only by simply inputting product information. Accordingly, a prospective purchaser may be assisted in making a purchase determination for a desired product through the output review keyword. In addition, the output review keyword may be used as a tool for analyzing the reputation of a brand or product.

The effect of the present invention is not limited to the effects mentioned above, and other effects not mentioned may be clearly understood by those skilled in the art to which the present invention pertains, from the description of the claims.

### BRIEF DESCRIPTION OF THE DRAWINGS

Embodiments of the present invention will be described with reference to the drawings described below, where like reference numerals denote like elements, but are not limited thereto.

FIG. 1 is a diagram illustrating a method of extracting a review keyword of a product provided according to an embodiment of the present invention.

FIG. 2 is a schematic diagram illustrating a configuration in which an information processing system is connected so as to be communicable with a plurality of user terminals in order to extract a product review keyword according to an embodiment of the present invention.

FIG. 3 is a block diagram illustrating an internal configuration of a user terminal and the information processing system according to an embodiment of the present invention.

FIG. 4 is a diagram illustrating a procedure of collecting review data according to an embodiment of the present invention.

FIG. 5 is a diagram illustrating filtering review data according to a property thereof according to an embodiment of the present invention.

FIG. 6 is a diagram illustrating a procedure of extracting a review keyword from review data according to an embodiment of the present invention.

FIG. 7 is a diagram illustrating preprocessing review data according to an embodiment of the present invention.

FIG. 8 is a diagram illustrating a process for training a language model to generate response data according to an embodiment of the present invention.

FIG. 9 is flowchart describing postprocessing of the generated response data according to an embodiment of the present invention.

FIG. 10 is a diagram illustrating a review keyword according to an embodiment of the present invention.

FIG. 11 is a flowchart illustrating an example of a method of extracting a product review keyword according to an embodiment of the present invention.

### DETAILED DESCRIPTION OF THE INVENTION

Hereinafter, specific contents for implementing the present invention will be described in detail with reference to the attached drawings. However, in the following description, specific descriptions regarding well-known functions or configurations will be omitted if they unnecessarily obscure the gist of the present invention.

In the attached drawings, the same or corresponding components are assigned the same reference numerals. In addition, in the descriptions of the embodiments below, descriptions of the same or corresponding components may be omitted to avoid redundancy.

The advantages and features of the disclosed embodiments, and the methods for achieving the embodiments, will become apparent with reference to the embodiments described below together with the attached drawings. However, the present invention is not limited to the embodiments disclosed below, but may be implemented in various other forms, and the embodiments are merely provided to make the present disclosure complete and to fully convey the scope of the invention to those skilled in the art.

Terms used in this specification will be briefly described, and the disclosed embodiments will be described in detail. The terms used in the specification are selected from general terms currently widely used in the art in consideration of functions in the present invention, but the terms may vary according to the intention of those skilled in the art, precedents, or new technology in the art. In addition, in specific cases, there are terms arbitrarily selected by the applicant, and in this case, the meaning of the terms will be described in detail in the description of the corresponding invention.

In this specification, singular expressions shall be understood to include plural expressions unless clearly specified as singular in the context. In addition, plural expressions shall be understood to include singular expressions unless clearly specified as plural in the context.

Further, the terms “module” or “unit” used in the specification refer to software or hardware components, and the “module” or “unit” performs specific roles. However, the “module” or “unit” is not limited to software or hardware. The term “module” or “unit” may be configured to be in an addressable storage medium or configured to reproduce one or more processors. Therefore, as an example, the “module” or “unit” may include at least one of components such as software components, object-oriented software components, class components, and task components, processes, functions, attributes, procedures, subroutines, segments of program code, drivers, firmware, microcode, circuits, data, databases, data structures, tables, arrays, or variables. The functions provided in the components and “modules” or “units” may be combined into a smaller number of components and “modules” or “units” or may be further divided into additional components and “modules” or “units”.

According to an embodiment of the present invention, “module” or “unit” may be implemented by a processor and memory. A “processor” should be broadly interpreted to include a central processing unit (CPU), a microprocessor, a digital signal processor (DSP), a controller, a microcontroller, a state machine, or the like. In some environments, a “processor” may refer to an application-specific integrated circuit (ASIC), a programmable logic device (PLD), a field-programmable gate array (FPGA) or the like. A “processor” may, for example, refer to a combination of processing devices such as a combination of a DSP and a microprocessor, a combination of multiple microprocessors, a combination of one or more microprocessors coupled with a DSP core, or a combination of any other such configuration. In addition, a “memory” should be broadly interpreted to include any electronic component capable of storing electronic information. A “memory” may refer to various types of processor-readable media such as a random access memory (RAM), a read-only memory (ROM), a non-volatile random access memory (NVRAM), a programmable read-only memory (PROM), an erasable and programmable read-only memory (EPROM), an electrically erasable PROM (EEPROM), a flash memory, a magnetic or optical data storage device, and registers. If a processor reads information from a memory and/or write information to the memory, the memory is said to be in a state of electronic communication with the processor. A memory integrated with a processor is in a state of electronic communication with the processor.

In the present disclosure, a “system” may include at least one of a server device or a cloud device, but is not limited thereto. For example, a system may be composed of one or more server devices. As another example, a system may be composed of one or more cloud devices. As yet another example, a system may be configured such that a server device and a cloud device operate together.

In the present disclosure, a “display” may refer to any display device associated with a computing device, and may refer to any display device capable of displaying arbitrary information/data provided or controlled by the computing device, for example.

In the present disclosure, the expression “each of a plurality of A” may refer to each of all the components included in the plurality of A, or each of some of the components included in the plurality of A.

In the present disclosure, a “machine learning model” may include any model or a computer program used to infer a solution (answer) for a given input. According to an embodiment, a machine learning model may include an artificial neural network model including an input layer, a plurality of hidden layers, and an output layer. Here, each layer may include a plurality of nodes. In the present disclosure, although a plurality of machine learning models are described as separate machine learning models, the present invention is not limited thereto, and some or all of the plurality of machine learning models may be implemented as one machine learning model. In addition, one machine learning model may include a plurality of machine learning models. In the present disclosure, the terms machine learning model and artificial neural network model may be used interchangeably to refer to the same or similar model. In addition, in the present disclosure, a “language model” may refer to a machine learning model or an artificial neural network model configured to calculate probabilities for at least a part of a sequence of one or more words or a sentence, or to generate a part of a sequence of words or a sentence.

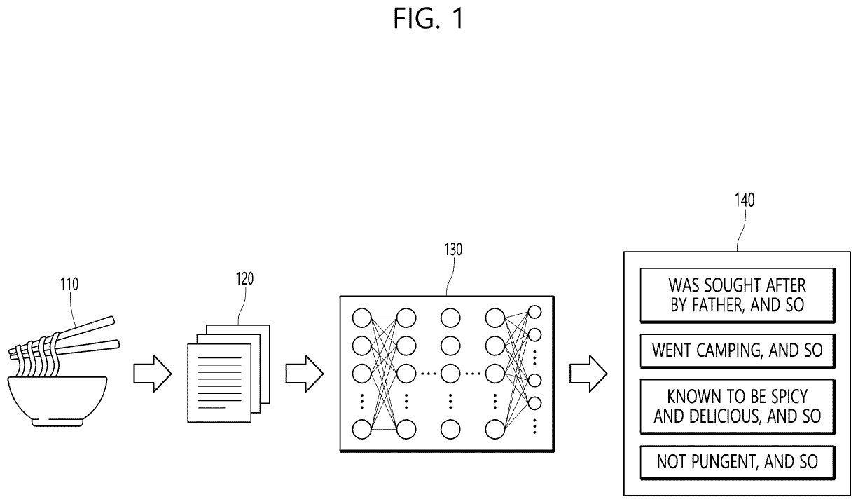

FIG. 1 illustrates an example of a method of extracting a review keyword 140 of a product 110 provided according to an embodiment of the present invention. According to an embodiment, based on information for specifying the product 110, review data 120 associated with the product 110 may be collected from a data source (e.g., a blog, a smart store, an internet cafe, a homepage of a company associated with the product, etc.). Here, the information for specifying the product may be a predetermined product name, a product number, or a catalog ID associated with the product. In addition, the review data 120 may be generated within a predetermined period (e.g., within the last one year).

According to an embodiment, by using a language model 130, at least one piece of response data may be generated from at least a part of the review data 120 based on a plurality of predetermined questions. Here, the plurality of predetermined questions may be questions associated with a usage target of the product, a purchase intention of the product, advantages of the product, disadvantages of the product, purchase history/plan, associated product/brand mentioned with the product, a purchase source of the product, a recognition path of the product, ingredients/applied technologies of the product, an appearance of the product, a nickname of the product, usage methods of the product, a collaboration/planning of the product, or the like. For example, by inputting question data associated with a recognition path of the product, such as “How did you find out about this product?” and the review data 120 into the language model 130, response data (e.g., “Known to be spicy and delicious, and so”) corresponding to the question may be generated.

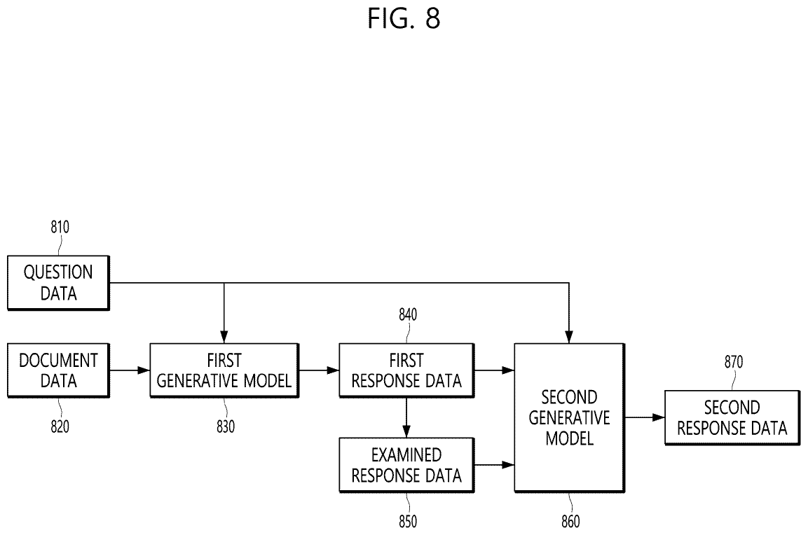

According to an embodiment, the language model 130 may generate response data corresponding to question data by inputting document data (e.g., product review data) and the question data. In addition, the language model 130 may be a sequence-to-sequence model. Additionally, the language model 130 may be a machine learning model trained using a predetermined training dataset including document data or question data. The process of training the language model 130 will be described in detail below with reference to FIG. 8.

According to an embodiment, the response data for the plurality of predetermined questions may be converted into embedding vectors. In addition, based on distances between the embedding vectors, by clustering the embedding vectors, at least one group may be generated. In this case, a representative keyword may be extracted from each of the at least one group. Here, the representative keyword may be determined based on the frequency of keywords included in the at least one group.

According to an embodiment, based on the at least one piece of response data, the review keyword 140 associated with the product 110 may be extracted. For example, the review keyword 140 may include keywords such as “Was sought after by father, and so” associated with the usage target of the product, “Went camping, and so” associated with the usage method of the product, “Known to be spicy and delicious, and so” associated with the recognition path of the product, and “Not pungent, and so” associated with the advantage of the product.

With this configuration, a user may easily identify the review keyword of the product only by inputting the information for specifying the product. Accordingly, the user may easily understand and analyze information or characteristics of an associated brand or product, based on product reviews of other users who have purchased or used the product. In addition, by providing the review keyword, it may help the user to determine whether to purchase the product.

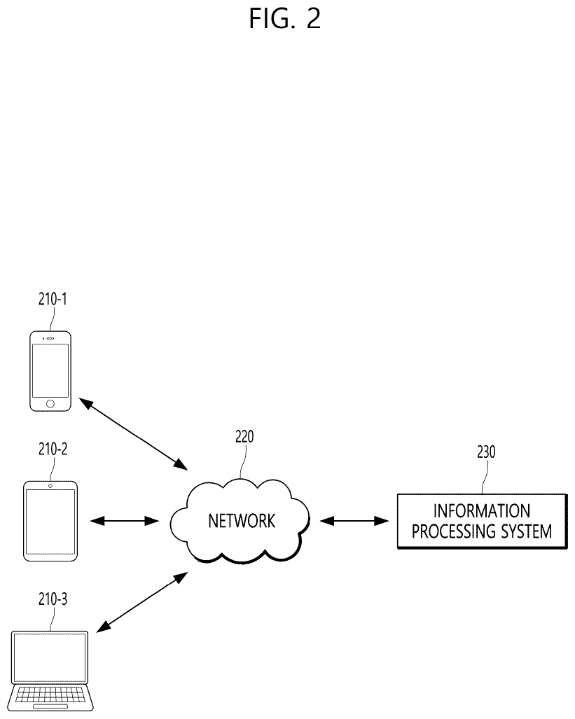

FIG. 2 is a schematic diagram illustrating a configuration in which an information processing system 230 is connected so as to be communicable with a plurality of user terminals 210_1, 210_2, 210_3 in order to extract a product review keyword according to an embodiment of the present invention. As illustrated, the plurality of user terminals 210_1, 210_2, 210_3 may be connected to the information processing system 230, which may provide a product review keyword extraction service, through a network 220. Here, the plurality of user terminals 210_1, 210_2, 210_3 may receive the product review keyword extraction service.

According to an embodiment, the information processing system 230 may include one or more server devices and/or databases capable of storing, providing, and executing computer-executable programs (e.g., downloadable applications) and data associated with providing the product review keyword extraction service, etc., or one or more distributed computing devices and/or distributed databases based on cloud computing services.

The product review keyword extraction service provided by the information processing system 230 may be provided to users through a product review keyword extraction service application web browser, a web browser extension, or the like installed in each of the plurality of user terminals 210_1, 210_2, 210_3. For example, the information processing system 230 may provide information corresponding to a product review keyword extraction request received from the user terminals 210_1, 210_2, 210_3 through a product review keyword extraction service application.

The plurality of user terminals 210_1, 210_2, 210_3 may communicate with the information processing system 230 via the network 220. The network 220 may be configured to enable communication between the plurality of user terminals 210_1, 210_2, 210_3 and the information processing system 230. The network 220, depending on the installation environment, may be composed of a wired network, such as Ethernet, wired home network (Power Line Communication), telephone line communication device, or RS-serial communication, a wireless network such as a mobile communication network, wireless LAN (WLAN), Wi-Fi, Bluetooth, and ZigBee, or a combination thereof. The communication method is not limited and may include not only communication methods using a communication network that may be included in the network 220 (e.g., mobile communication network, wired Internet, wireless Internet, broadcasting network, satellite network, etc.) but also short-range wireless communication between the user terminals 210_1, 210_2, 210_3.

Although in FIG. 2, a mobile phone terminal 210_1, a tablet terminal 210_2, and a PC terminal 210_3 are illustrated as examples of the user terminals, the user terminals 210_1, 210_2, 210_3 are not limited thereto and may be any computing device capable of wired and/or wireless communication and capable of installing and executing a product review keyword extraction service application, web browser, or the like. For example, the user terminals may include an AI speaker, a smartphone, a mobile phone, navigation, a computer, a notebook, a digital broadcasting terminal, a personal digital assistant (PDA), a portable multimedia player (PMP), a tablet PC, a game console, a wearable device, an Internet of Things (IoT) device, a virtual reality (VR) device, an augmented reality (AR) device, a set-top box, or the like. In addition, although FIG. 2 illustrates three user terminals 210_1, 210_2, 210_3 communicating with the information processing system 230 via the network 220, the present invention is not limited thereto, and a different number of user terminals may be configured to communicate with the information processing system 230 via the network 220.

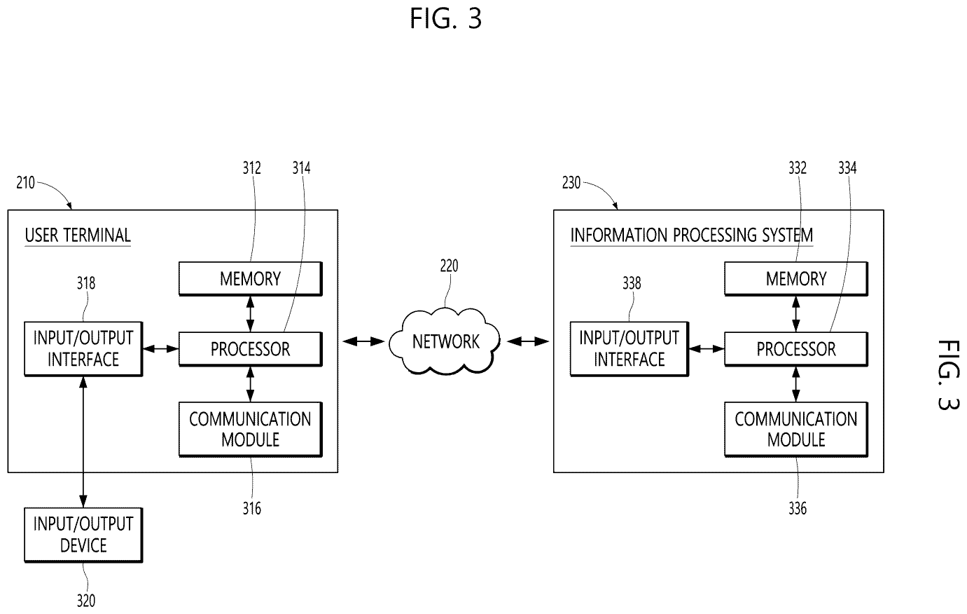

FIG. 3 is a block diagram illustrating an internal configuration of a user terminal 210 and the information processing system 230 according to an embodiment of the present invention. The user terminal 210 may refer to any computing device capable of executing an application, a web browser, or the like, and capable of wired/wireless communication, and may include, for example, the mobile phone terminal 210_1, tablet terminal 210_2, and PC terminal 210_3 in FIG. 2. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As illustrated in FIG. 3, the user terminal 210 and the information processing system 230 may be configured to communicate information and/or data via the network 220 by using the respective communication modules 316 and 336. In addition, an input/output device 320 may be configured to input information and/or data to the user terminal 210, or to output information and/or data generated from the user terminal 210, through the input/output interface 318.

The memories 312 and 332 may include any non-transitory computer-readable recording medium. According to an embodiment, the memories 312 and 332 may include permanent mass storage devices such as a read only memory (ROM), a disk drive, a solid state drive (SSD), or a flash memory. As another example, permanent mass storage devices such as a ROM, an SSD, a flash memory, and a disk drive may be included in the user terminal 210 or the information processing system 230 as separate permanent storage devices distinguished from the memories 312 and 332. In addition, at least one program code and an operating system may be stored in the memories 312 and 332.

Such software components may be loaded from a separate computer-readable recording medium different from the memories 312 and 332. Such a separate computer-readable recording medium may include a recording medium directly connectable to the user terminal 210 or the information processing system 230, and may include, for example, computer-readable recording media such as a floppy drive, disk, tape, DVD/CD-ROM drive, or a memory card. As another example, the software components may be loaded into the memories 312 and 332 through the communication modules 316 and 336, not from a computer-readable recording medium. For example, at least one program may be loaded into the memories 312 and 332 based on a computer program installed by a file provided via the network 220 by developers or by a file distribution system distributing an installation file of an application.

The processors 314 and 334 may be configured to process commands of the computer program by performing basic arithmetic, logic, and input/output operations. The commands may be provided to the processors 314 and 334 by the memories 312 and 332 or the communication modules 316 and 336. For example, the processors 314 and 334 may be configured to execute commands received according to program code stored in a recording device such as the memories 312 and 332.

The communication modules 316 and 336 may provide a configuration or function for the user terminal 210 and the information processing system 230 to communicate with each other via the network 220, and may provide a configuration or function for the user terminal 210 and/or the information processing system 230 to communicate with another user terminal or another system (e.g., a separate cloud system, etc.). For example, a request or data (e.g., a product review keyword extraction request) generated by the processor 314 of the user terminal 210 according to program code stored in a storage device such as the memory 312 may be transmitted to the information processing system 230 via the network 220 under the control of the communication module 316. Conversely, a control signal or command provided under the control of the processor 334 of the information processing system 230 may be received by the user terminal 210 through the communication module 316 of the user terminal 210 via the communication module 336 and network 220.

The input/output interface 318 may be a means for interfacing with the input/output device 320. As an example, the input device of the input/output interface 318 may include devices such as a camera including an audio sensor and/or an image sensor, a keyboard, a microphone, and a mouse, and the output device of the input/output interface 318 may include a device such as a display, a speaker, and a haptic feedback device. As another example, the input/output interface 318 may be a means for interfacing with a device in which configurations or functions for performing input and output are integrated into one, such as a touchscreen. For example, when the processor 314 of the user terminal 210 processes commands of a computer program loaded into the memory 312, a service screen, etc. configured using information and/or data provided by the information processing system 230 or another user terminal may be displayed on the display through the input/output interface 318. Although in FIG. 3, the input/output device 320 is illustrated as not being included in the user terminal 210, the present invention is not limited thereto, and the user terminal 210 and the input/output device 320 may be configured as a single device. In addition, the input/output interface 338 of the information processing system 230 may be a means for interfacing with a device (not illustrated) for input or output that may be connected to or included in the information processing system 230. In FIG. 3, the input/output interfaces 318 and 338 are illustrated as components configured separately from the processors 314 and 334, but the present invention is not limited thereto, and the input/output interfaces 318 and 338 may be configured to be included in the processors 314 and 334.

The user terminal 210 and the information processing system 230 may include more components than those of FIG. 3. For example, the user terminal 210 may be implemented to include at least a part of the input/output device 320 described above. In addition, the user terminal 210 may further include other components such as a transceiver, a global positioning system (GPS) module, a camera, various sensors, and a database. When the user terminal 210 is a smartphone, it may include components typically included in a smartphone. The user terminal 210 may also be implemented to further include various components such as an accelerometer, a gyroscope sensor, a microphone module, a camera module, various physical buttons, touch panel-based buttons, input/output ports, and a vibrator for vibration.

While a program for a product review keyword extraction service application is being executed, the processor 314 may receive text, image, video, voice, and/or operation, etc. input or selected through an input device such as a touchscreen, keyboard, camera including an audio sensor and/or an image sensor, or a microphone, which are connected to the input/output interface 318, and may store the received text, image, video, voice, and/or operation, etc. in the memory 312 or provide them to the information processing system 230 through the communication module 316 and the network 220.

The processor 314 of the user terminal 210 may be configured to manage, process, and/or store information and/or data received from the input/output device 320, another user terminal, the information processing system 230, and/or a plurality of external systems. The information and/or data processed by the processor 314 may be provided to the information processing system 230 through the communication module 316 and the network 220. The processor 314 of the user terminal 210 may transmit information and/or data to the input/output device 320 through the input/output interface 318, to output the information and/or data. For example, the processor 314 may output the received information and/or data on the screen of the user terminal 210.

The processor 334 of the information processing system 230 may be configured to manage, process, and/or store information and/or data received from a plurality of user terminals 210 and/or a plurality of other external systems. The information and/or data processed by the processor 334 may be provided to the user terminal 210 through the communication module 336 and the network 220.

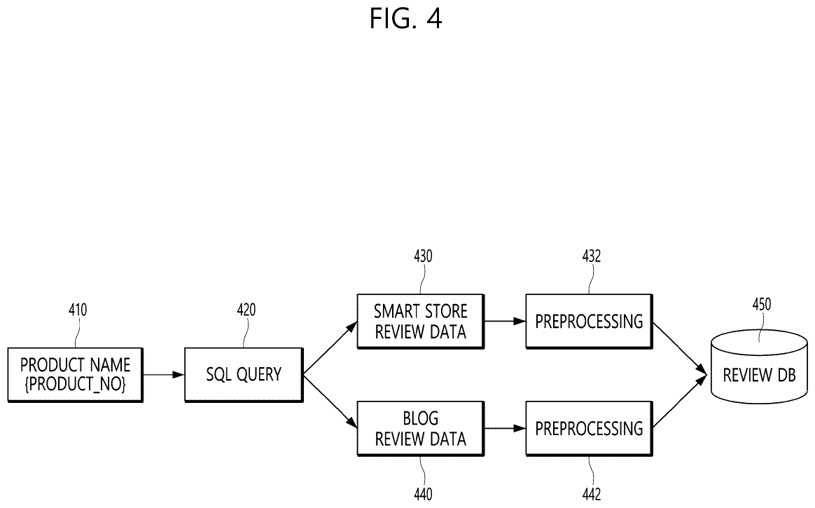

FIG. 4 illustrates an example of a procedure of collecting review data according to an embodiment of the present disclosure. As illustrated, review data may be collected from one or more data sources or databases by using a database search command 420 (e.g., an SQL query) including information 410 for specifying a product (e.g., a product name, a product number, a catalog ID, etc.). In FIG. 4, it is illustrated that the review data is collected from blogs and smart stores based on the product name (or product number), but the present invention is not limited thereto, and the review data may be collected from internet cafes, internet news, a homepage of a company associated with the product, or text converted from voice of a review video.

According to an embodiment, smart store review data 430 collected from a smart store may be preprocessed 432. For example, by filtering the smart store review data 430, only the review data generated within a predetermined period (e.g., 1 year) may be extracted. In addition, predetermined forbidden words or special characters included in the smart store review data 430 may be removed.

According to an embodiment, blog review data 440 collected from a blog may be preprocessed 442. For example, by filtering the blog review data 440, only the review data generated within a predetermined period (e.g., the last 1 year) may be extracted. In addition, since the blog review data 440 has a large data size, it may be divided into an arbitrary number of chunks. Additionally, predetermined forbidden words or special characters included in the blog review data 440 may be removed.

According to an embodiment, the preprocessed smart store review data and the preprocessed blog review data may be stored in a review database 450. In this case, the review data may be stored in correspondence with at least one of a plurality of predetermined questions. For example, the review data may be classified as review data associated with a purchase intention of the corresponding product, review data associated with an advantage of the corresponding product, review data associated with a recognition path of the corresponding product, or the like, and stored in the review database 450.

According to an embodiment, the operations illustrated in FIG. 4, including the database search command 420, the collection of smart store review data 430 and its preprocessing 432, and the collection of blog review data 440 and its preprocessing 442, may be executed by the processor 334 of the information processing system 230. In particular, the processor 334 may load and execute one or more program instructions stored in the memory 332 to perform the database search command including product information 410, and to control the preprocessing of the collected smart store review data 430 and the collected blog review data 440.

Further, the preprocessed review data may be stored in a review database 450 configured in the memory 332 or the storage 338 of the information processing system 230. In this case, the review database 450 may represent a logical storage area formed under the control of the processor 334, and the review data may be classified in correspondence with at least one of a plurality of predetermined questions (e.g., purchase intention, advantages of the product, recognition path of the product, etc.) before being stored in the review database 450.

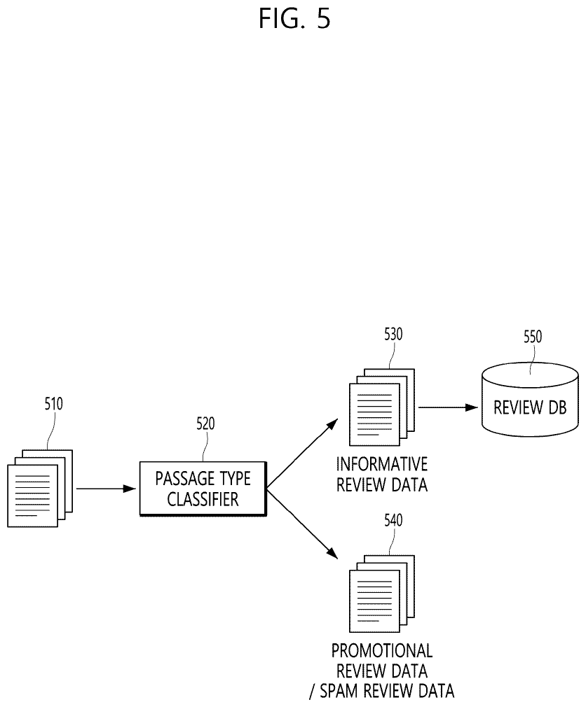

FIG. 5 illustrates an example of filtering review data 510 according to a property thereof according to an embodiment of the present invention. According to an embodiment, the review data 510 collected from a blog or a smart store may be classified into informative review data 530 and spam/promotional review data 540 through a passage-type classifier (PTC) 520. Here, the informative review data 530 may be determined to include a real user's review information on various characteristics of the product, and may be stored in a review database 550. In contrast, when the collected review data is a spam/promotional review, it may be determined to include promotional phrases (e.g., “This review may earn you a commission.”). Due to such spam/promotional review data, an inappropriate review keyword not corresponding to a predetermined question may be extracted in a subsequent review keyword extraction step.

According to an embodiment, the passage-type classifier 520 may be a language model or a machine learning model that determines the informative review data 530 from the review data 510. For example, by training on a training dataset and ground truth dataset for abusing document filtering, the passage-type classifier 520 may determine whether specific review data is informative review data or review data with other properties. Since the passage-type classifier 520 needs to perform inference on a large amount of review data, it may be, for example, a relatively lightweight form of BERT model, but is not limited thereto. With such a configuration, by removing the spam/promotional review data from the review data using the passage-type classifier 520, the property of the review data may be simplified during the review keyword extraction. That is, only informative review data may be extracted from the review data, and used in a subsequent review keyword extracting step. Accordingly, uncertainty of the review keyword extracted in the review keyword extracting step may be reduced, so that the reliability of the review keyword may be improved.

According to an embodiment, the operation of the passage-type classifier (PTC) 520 illustrated in FIG. 5 may be executed by the processor 334 of the information processing system 230. In particular, the processor 334 may load and execute program instructions implementing the passage-type classifier 520, which may include a machine learning model such as a lightweight BERT model, from the memory 332 or the storage 338. By executing such instructions, the processor 334 may classify the collected review data 510 into informative review data 530 and spam/promotional review data 540. The informative review data 530 determined by the processor 334 may then be stored in the review database 550 implemented within the memory 332 or the storage 338 of the information processing system 230.

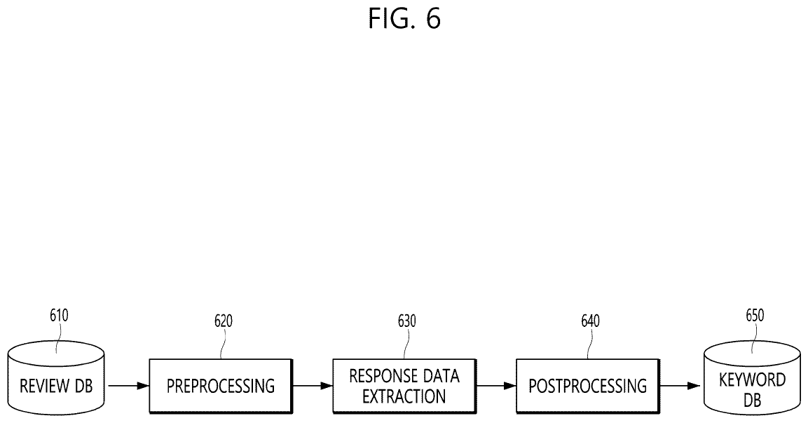

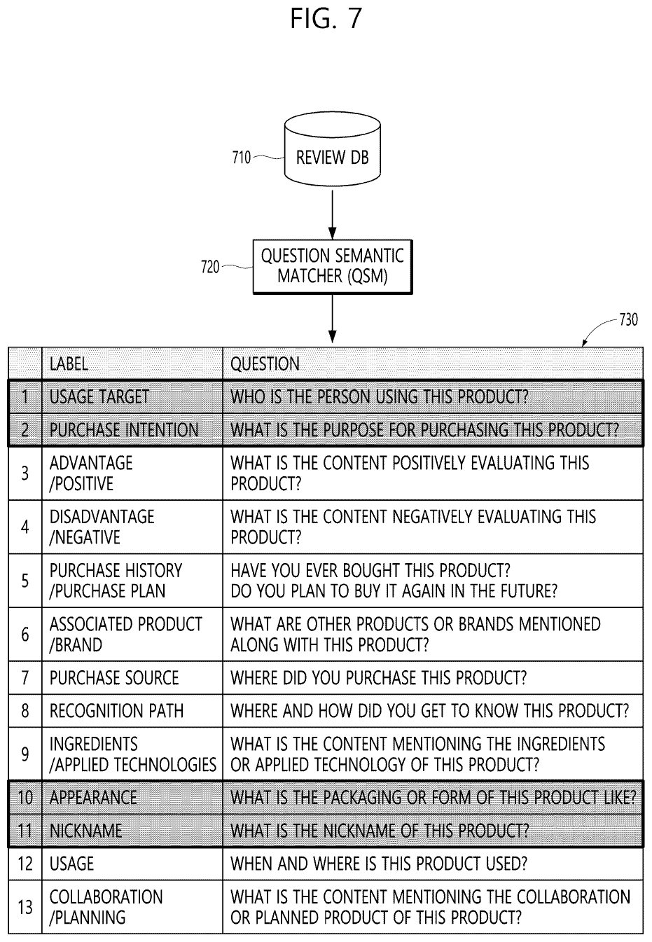

FIG. 6 illustrates an example of a procedure of extracting a review keyword from review data according to an embodiment of the present invention. According to an embodiment, by identifying whether a response to at least a part of a plurality of predetermined questions is included in the review data stored in a review database 610 using the language model 130, the review data may be preprocessed 620. Examples of the review data being preprocessed will be described in detail below with reference to FIG. 7. According to an embodiment, when the review data includes responses to at least a part of a plurality of predetermined questions, at least a part of the review data may be extracted as response data corresponding to at least a part of the plurality of predetermined questions 630. In addition, a postprocessing process such as removing duplicated sentences from the extracted response data, or removing sentences that are different from the original review data, may be executed 640. Additionally, by clustering similar response data into at least one group, a representative keyword of each of the at least one group may be extracted and stored as a review keyword in a keyword database 650.

According to an embodiment, the operations illustrated in steps 620, 630, and 640 of FIG. 6 may be executed by the processor 334 of the information processing system 230. In particular, the processor 334 may load and execute program instructions stored in the memory 332 to extract review keywords in step 620, to classify or map the extracted keywords in step 630, and to associate and store the results in step 640. The results processed in step 640 may be stored in a review database implemented within the memory 332 or the storage 338 of the information processing system 230 under the control of the processor 334.

FIG. 7 illustrates an example of preprocessing review data according to an embodiment of the present invention. According to an embodiment, by preprocessing the review data stored in a review database 710 through a question semantic matcher (QSM) 720, it may be determined whether response data corresponding to at least a part of the plurality of predetermined questions 730 may be extracted from the review data. Even in a case where the review data does not include response data corresponding to a specific question among the plurality of predetermined questions 730, when a response to the corresponding question is extracted, inappropriate response data may be generated. Therefore, through an appropriate preprocessing step, the generation of inappropriate response data may be prevented.

According to an embodiment, the question semantic matcher 720 may be a machine learning model that determines whether response data corresponding to at least a part of the plurality of predetermined questions 730 may be extracted from the review data. The question semantic matcher 720 may be trained based on document data, question data, and ground truth dataset, and may determine whether a response corresponding to each of the plurality of predetermined questions 730 exists in the review data. For example, through the question semantic matcher 720, it may be determined that responses corresponding to questions associated with a usage target of the product, a purchase intention of the product, an appearance of the product, and a nickname of the product exist in the review data. In this case, only response data corresponding to the corresponding questions may be finally generated, and generation of inappropriate response data corresponding to the remaining questions may be prevented.

The review database 550 in FIG. 5, the review database 610 in FIG. 6, and the review database 710 in FIG. 7 may represent the same review database 450 illustrated in FIG. 4, but shown with different reference numbers in order to indicate that the review data stored therein corresponds to the respective processing steps.

According to an embodiment, the operations of the question semantic matcher 720 may be executed by the processor 334 of the information processing system 230. In particular, the processor 334 may execute program instructions stored in the memory 332 to perform semantic matching between the extracted review keywords and a plurality of predetermined questions. The processor 334 may further control the memory 332 or the storage 338 to store the matching results in association with the corresponding questions in a review database.

Through such a configuration, whether responses corresponding to at least a part of the plurality of predetermined question data are included in the review data may be identified. That is, a characteristic of information included in the review data may be identified in advance. Accordingly, uncertainty in the review keyword extracting step may be reduced, thereby improving the reliability of the review keyword.

FIG. 8 illustrates an example of training the language model 130 to generate response data according to an embodiment of the present invention. According to an embodiment, the language model 130 for generating response data may be trained using a predetermined training dataset. Specifically, a set of question data 810 and document data 820 may be input into a first generative model 830. In this case, the first generative model 830 may pseudo-label at least a part of the document data 820 as first response data 840 for a specific question in the question data 810. Here, the first response data 840 may include an inappropriate noise response for the specific question. For example, when the specific question is associated with a recognition path of the product, a noise response associated with an advantage of the product, which is distant from the specific question, may be generated from the first generative model 830.

According to an embodiment, to reduce such noise responses, a second generative model 860 may be additionally used. Specifically, a part of the first response data 840 may be examined, and noise may be removed therefrom. For example, the examination of the response data may be passively performed by an operator of the system. Accordingly, the examined response data 850 may be regarded as ground truth data. Here, for the efficiency of the examination, all of the first response data 840 need not be examined. In addition, the second generative model 860 may be trained using the specific question corresponding to the first response data 840 and the examined response data 850. In this case, by inputting the remaining part of the first response data 840 that has not been examined into the second generative model 860, the second generative model 860 may label the corresponding part of the first response data 840 as second response data 870. By using the second generative model 860 trained as described above, response data may be generated from the review data.

With such a configuration, by using an additional generative model in addition to the generative model that extracts response data corresponding to question data from review data (or document data), the quality of the output response data may be improved. In addition, by training the additional generative model by examining only a part of all the response data extracted by the generative model, without examining all of them, an examination efficiency of the response data may be improved.

According to an embodiment, the first generative model 830 and the second generative model 860 may be defined as sub-models of the language model 130 used for training to generate answer data. Specifically, the first generative model 830 may receive question data 810 and document data 820, and may generate pseudo-labeled first answer data 840. Since the first answer data 840 may include noise, corrected answer data 850 may be obtained by inspection. The second generative model 860 may then be trained using the corrected answer data 850 to reduce noise and generate refined second answer data. Thus, the first generative model 830 and the second generative model 860 may function as internal modules of the language model 130, and may be executed by the processor 334 of the information processing system 230 using program instructions stored in the memory 332 or the storage 338.

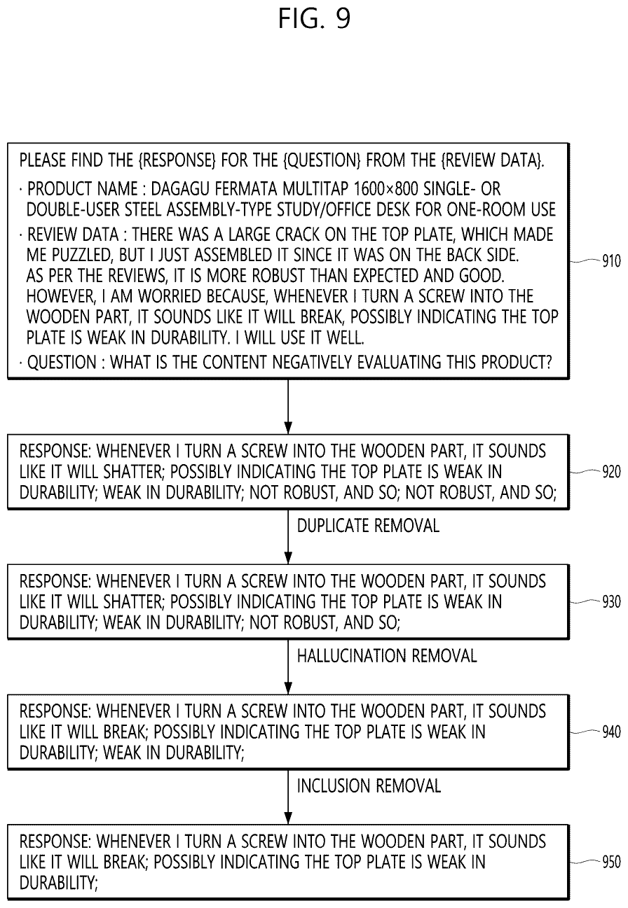

FIG. 9 illustrates an example of postprocessing the generated response data according to an embodiment of the present invention. According to an embodiment, first response data 920 may be generated from input data 910 by using the language model 130. Here, the input data 910 input to the language model 130 may include information for specifying a product (e.g., product name, etc.), review data, and question data. For example, the language model 130 may generate, as first response data 920 corresponding to a question associated with the disadvantage of the product, from review data associated with a specified product (e.g., an assembled desk), “whenever I turn a screw into the wooden part, it sounds like it will shatter; possible indicating the top plate is weak in durability; weak in durability; not robust, and so; not robust, and so;”.

According to an embodiment, by postprocessing the first response data 920 generated by the language model 130, second response data 930 may be generated. Specifically, in the first response data 920, duplicated sentences may be removed. For example, since “not robust, and so” is duplicated in the first response data 920, the second response data 930 may be generated by removing the corresponding sentence.

According to an embodiment, by postprocessing the second response data 930, third response data 940 may be generated. Specifically, in the second response data 930, a hallucinated sentence that does not exist in the original review data may be removed. For example, since “not robust, and so” does not exist in the original review data in the second response data 930, the third response data 940 may be generated by removing the corresponding sentence. In addition, even if a sentence in the second response data 930 does not exist in the original review data, the sentence slightly modified due to spacing, punctuation, grammar changes, or the like may be replaced with a corresponding sentence included in the original review data. For example, “whenever I turn a screw into the wooden part, it sounds like it will shatter” in the second response data 930 is similar to “whenever I turn a screw into the wooden part, it sounds like it will break” in the original review data, so it may be replaced with the corresponding sentence included in the original review data. Here, when a match score between the response data and a part of the review data is equal to or greater than a predetermined threshold, it may be determined that the response data and the part of the review data are similar to each other, and the corresponding part of the review data may replace the corresponding response data.

According to an embodiment, by postprocessing the third response data 940, fourth response data 950 may be generated. Specifically, in the third response data 940, a sentence having an inclusion relationship may be removed. For example, “weak in durability” in the third response data 940 is included in “possibly indicating the top plate is weak in durability,” so the fourth response data 950 may be generated by removing the sentence having the inclusion relationship. Here, among the sentences in the inclusion relationship, the remaining sentences except for the sentence with the longest length may be removed.

According to an embodiment, based on the postprocessed response data, a review keyword may be extracted. Specifically, each of the postprocessed response data may be converted into an embedding vector by using an artificial neural network-based model. In addition, based on distances between embedding vectors, the embedding vectors may be clustered into at least one group. For example, a plurality of embedding vectors may be clustered by using a K-means algorithm, but is not limited thereto. In this case, from each of the at least one group, a representative keyword may be extracted as a review keyword. Here, the representative keyword may be determined based on the frequency of keywords included in the at least one group.

With such a configuration, by postprocessing the response data extracted from the review data in response to the question data, accuracy or reliability of the review keyword extracted therefrom may be improved. In addition, by reflecting at least a part of a sentence of original review data in the review keyword, the reliability of the finally extracted review keyword may be improved.

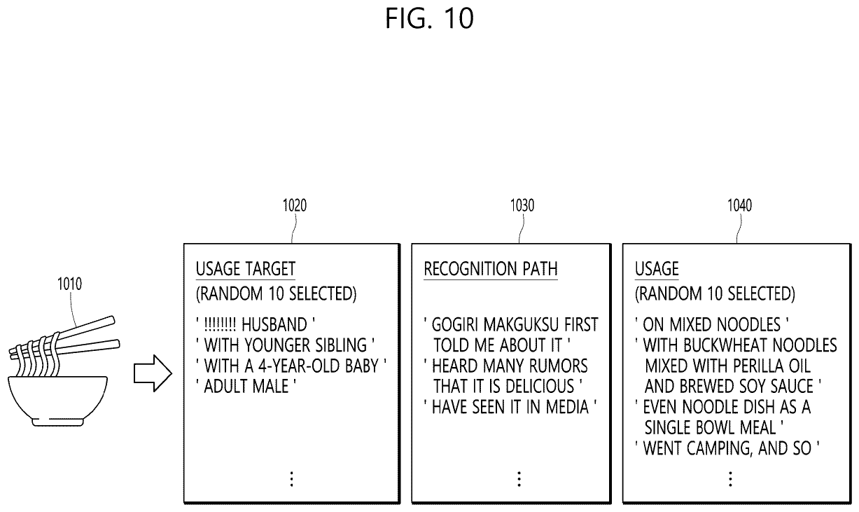

FIG. 10 illustrates an example of review keywords 1020 to 1040 according to an embodiment of the present invention. As illustrated, review keywords 1020 to 1040 associated with a product 1010 may be extracted through the language model 130. Here, the review keywords 1020 to 1040 may be output according to labels associated with a plurality of predetermined questions.

For example, when the product is Gogiri Makguksu, as a review keyword 1020 associated with a usage target of the product, “!!!!!!! husband”, “with younger sibling”, “with a 4-year-old baby”, or the like may be output. In addition, as a review keyword 1030 associated with a recognition path of the product, “Gogiri Makguksu first told me about it”, “heard many rumors that it is delicious”, “have seen it in media”, or the like may be output. Additionally, as a review keyword 1040 associated with usage methods of the product, “on mixed noodles”, “with buckwheat noodles mixed with perilla oil and brewed soy sauce”, “even noodle dish as a single bowl meal”, or the like may be output.

In FIG. 10, review keywords according to three labels are illustrated, but are not limited thereto, and review keywords according to more various labels may be output. In addition, although it is illustrated that up to ten review keywords are arbitrarily selected and output according to each of the labels, the present invention is not limited thereto.

With such a configuration, a user may easily identify a review keyword associated with the corresponding product only by simply inputting product information. Accordingly, a prospective purchaser may be assisted in making a purchase determination for a desired product through the output review keyword. In addition, the output review keyword may be used as a tool for analyzing the reputation of a brand or product.

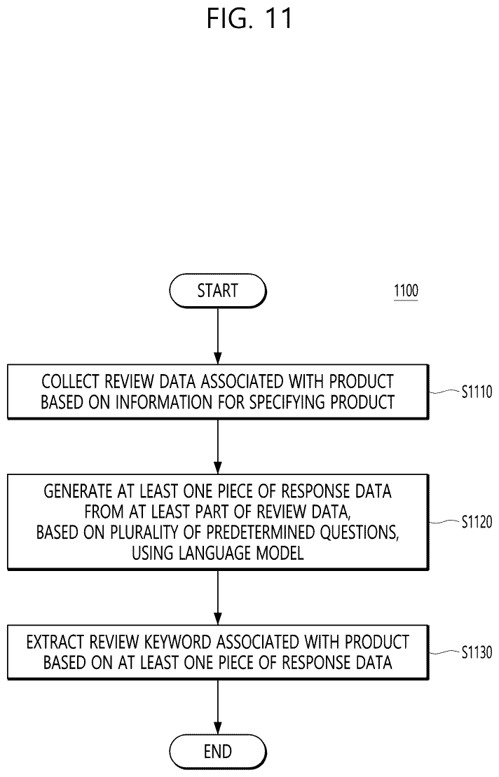

FIG. 11 is a flowchart illustrating an example of a method 1100 for extracting a product review keyword according to an embodiment of the present invention. In an embodiment, the method 1100 may be performed by the processor 334. The method 1100 may begin with the processor 334 collecting review data associated with a product, based on information for specifying the product (S1110). Here, the information for specifying the product may be a predetermined product name, a product number, or a catalog ID associated with the product. In addition, the review data associated with the product may be review data generated within a predetermined period.

Thereafter, the processor 334 may generate at least one piece of response data from at least a part of the review data, based on a plurality of predetermined questions, by using the language model 130 (S1120). In this case, the processor 334 may determine, by using the language model 130, whether the review data includes responses to at least a part of the plurality of predetermined questions. In addition, when it is determined that the review data includes responses to at least a part of the plurality of predetermined questions, the processor 334 may determine at least a part of the review data as response data corresponding to at least a part of the plurality of predetermined questions.

Thereafter, the processor 334 may extract review keywords associated with the product, based on the at least one piece of response data (S1130). Specifically, the processor 334 may postprocess the at least one piece of response data. In addition, the processor 334 may extract at least one review keyword associated with the product, from the postprocessed response data.

In an embodiment, the processor 334 may remove spam review data and promotional review data from the review data associated with the product, by using a machine learning model. In addition, the processor 334 may remove predetermined forbidden words or special characters from the review data associated with the product.

In an embodiment, the processor 334 may train the language model 130 by using a predetermined training dataset. Here, the predetermined training dataset may include at least one of document data or question data. Specifically, the processor 334 may pseudo-label at least a part of the document data as first response data for a specific question in the question data, through the first generative model 830, and may train the second generative model 860 by using a specific question and a part of the first response data. Additionally, the processor 334 may train the second generative model 860 by using the remaining part of the first response data and the specific question. In this case, the remaining part of the first response data may be examined response data. In addition, the processor 334 may, through the second generative model, label a part of the first response data as second response data for the specific question.

In an embodiment, the processor 334 may remove the response data including duplicated sentences from the at least one piece of response data. When a plurality of response data having an inclusion relationship exists in the at least one piece of response data, the processor 334 may remove the remaining response data except for one of the plurality of response data having the inclusion relationship. Additionally, the processor 334 may remove the remaining response data except for the response data with the longest length among the plurality of response data.

In an embodiment, the processor 334 may determine a sentence of the review data corresponding to at least a part of the response data, based on a match score between at least a part of the response data and the review data. Thereafter, when the match score is greater than or equal to a predetermined threshold, the processor 334 may replace at least a part of the response data with the sentence of the review data. In this case, when the match score is less than the predetermined threshold, the processor 334 may remove at least a part of the response data.

In an embodiment, the processor 334 may convert the response data for the plurality of predetermined questions into embedding vectors. In addition, based on distances between the embedding vectors, the processor 334 may generate at least one group. Additionally, the processor 334 may extract a representative keyword from each of the at least one group.

In an embodiment, the review data may be collected from blogs and smart stores. In this case, the review data associated with a part of the plurality of predetermined questions may be collected from blogs, and the review data associated with the remaining part of the plurality of predetermined questions may be collected from smart stores.

The above-described method may be provided as a computer program stored in a computer-readable recording medium for execution on a computer. The medium may continuously store computer-executable programs or temporarily store the programs for execution or download. In addition, the medium may include various recording means or storage means in which a single piece of hardware or several pieces of hardware are combined. The medium is not limited to a medium directly connected to any computer system, but may be distributed on a network. Examples of media may include magnetic media such as hard disks, floppy disks, and magnetic tapes, optical recording media such as CD-ROMs and DVDs, magneto optical media such as floptical disks, ROMs, RAMs, and flash memories and may be configured to store program instructions. In addition, examples of other media may include recording media and storage media which are managed by application stores that distribute applications, sites that supply or distribute various types of software, and servers.

The method, operation, or techniques of the present invention may also be implemented by various means. For example, such techniques may be implemented in hardware, firmware, software, or a combination thereof. Those of ordinary skill in the art will understand that various illustrative logical blocks, modules, circuits, and algorithm steps described in connection with the present disclosure may be implemented in electronic hardware, computer software, or a combination of both. In order to clearly describe the interchangeability of hardware and software, various illustrative components, blocks, modules, circuits, and steps have been described above generally in terms of their functionality. Whether such functionality is implemented as hardware or software depends on design requirements imposed on the specific application and overall system. Those skilled in the art may implement the described functionality in a variety of ways for each specific application, but such implementations should not be interpreted as departing from the scope of the present invention.

In a hardware implementation, the processing units used to perform the method may be implemented within one or more of ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computers, or a combination thereof.

Accordingly, various illustrative logical blocks, modules, and circuits described in connection with the present invention may be implemented or performed by a general-purpose processor, DSP, ASIC, FPGA, or other programmable logic device, discrete gate or transistor logic, discrete hardware components, or any combination thereof designed to perform the functions described herein. The general-purpose processor may be a microprocessor, but, alternatively, the processor may be any conventional processor, controller, microcontroller, or state machine. The processor may, in addition, be implemented as a combination of computing devices, for example, a DSP and a microprocessor, multiple microprocessors, one or more microprocessors in connection with a DSP core, or any other combination of configurations.

In a firmware and/or software implementation, the method may be implemented as instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage device. The instructions may be executed by one or more processors, and may cause the processor(s) to perform specific aspects of the functions described in the present disclosure.

When implemented in software, the method may be stored on a computer-readable medium as one or more instructions or code or transmitted through the computer-readable medium. The computer-readable medium includes both computer storage media and communication media, including any medium that facilitates the transmission of a computer program from one location to another. The storage media may be any available media that may be accessed by a computer. As a non-limiting example, such computer-readable media may include RAM, ROM, EEPROM, CD-ROM or other optical disk storage, magnetic disk storage or other magnetic storage devices, or any other medium that may be used to transfer or store desired program code in the form of instructions or data structures and that may be accessed by a computer. In addition, any connection is properly referred to as a computer-readable medium.

For example, when the software is transmitted from a website, server, or other remote source by using a coaxial cable, fiber optic cable, twisted pair, digital subscriber line (DSL), or wireless technologies such as infrared, radio, and microwave, the coaxial cable, fiber optic cable, twisted pair, digital subscriber line, or wireless technologies such as infrared, radio, and microwave are included within the definition of the medium. As used herein, the term disk and disc includes CD, laser disc, optical disc, digital versatile disc (DVD), floppy disk, and Blu-ray disc, where disks typically reproduce data magnetically, while discs reproduce data optically using lasers. Combinations of the above should also be included within the scope of computer-readable media.

Software modules may reside in RAM memory, flash memory, ROM memory, EPROM memory, EEPROM memory, registers, hard disk, removable disk, CD-ROM, or any other form of storage medium known in the art. An exemplary storage medium may be connected to the processor such that the processor may read information from the storage medium or write information to the storage medium. Alternatively, the storage medium may be integrated into the processor. The processor and the storage medium may exist in an ASIC. The ASIC may exist in a user terminal. Alternatively, the processor and the storage medium may exist as separate components in a user terminal.

Although the above-described embodiments have been described as using aspects of the presently disclosed subject matter in one or more standalone computer systems, the present invention is not limited thereto and may be implemented in connection with any computing environment, such as network or distributed computing environments. Furthermore, aspects of the subject invention in the present disclosure may be implemented across multiple processing chips or devices, and storage may similarly be affected across multiple devices. Such devices may include PCs, network servers, and portable devices.

In the present specification, although the present invention has been described in connection with some embodiments, various modifications and changes may be made without departing from the scope of the present invention as understood by those of ordinary skill in the art to which the invention pertains. In addition, such modifications and changes are to be considered as falling within the scope of the claims attached to the present specification.

1. A method of extracting a product review keyword performed by at least one processor, the comprising:
collecting review data associated with a product based on information for specifying the product;
generating at least one piece of response data from at least a part of the review data based on a plurality of predetermined questions using language model; and
extracting a review keyword associated with the product based on the at least one piece of response data.

2. The method of claim 1, further comprising:
removing spam review data and promotional review data from the review data associated with the product using a machine learning model.

3. The method of claim 1, wherein the generating of the at least one piece of response data comprises:
determining whether the review data includes responses to at least a part of the plurality of predetermined questions using the language model; and
determining the at least a part of the review data as response data corresponding to the at least a part of the plurality of predetermined questions, when it is determined that the review data includes responses to the at least a part of the plurality of predetermined questions.

4. The method of claim 1, further comprising:
training the language model using a predetermined training dataset,
wherein the predetermined training dataset includes at least one of document data or question data.

5. The method of claim 4, wherein the training of the language model, comprises:
pseudo-labeling at least a part of the document data as first response data for a specific question among the question data through a first generative model; and
training a second generative model using the specific question and a part of the first response data.

6. The method of claim 5, wherein a remaining part of the first response data is examined response data, and
wherein the training of the language model using the predetermined dataset further comprises:
training the second generative model using the specific question and the remaining part of the first response data; and
labeling a part of the first response data as second response data for the specific question through the second generative model.

7. The method of claim 1, wherein the extracting of the review keyword associated with the product based on the at least one piece of response data comprises:
postprocessing the at least one piece of response data; and
extracting at least one review keyword associated with the product from the postprocessed response data.

8. The method of claim 7, wherein the postprocessing of the at least one piece of response data comprises:
removing response data including duplicated sentences from the at least one piece of response data.

9. The method of claim 7, wherein the postprocessing of the at least one piece of response data comprises:
determining a sentence of the review data corresponding to at least a part of the response data based on a match score between at least a part of the response data and the review data; and
replacing the at least a part of the response data with the sentence of the review data when the match score is equal to or greater than a predetermined threshold.

10. The method of claim 9, wherein the postprocessing of the at least one piece of response data further comprises:
removing the at least a part of the response data when the match score is less than the predetermined threshold.

11. The method of claim 7, wherein the postprocessing of the at least one piece of response data comprises:
removing remaining response data, except for one of a plurality of response data having an inclusion relationship when the plurality of response data having the inclusion relationship exist in the at least one piece of response data.

12. The method of claim 11, wherein the postprocessing of the at least one piece of response data further comprises:
removing remaining response data, except for response data with the longest length among the plurality of response data.

13. The method of claim 1, wherein the extracting of the review keyword associated with the product based on the at least one piece of response data comprises:
converting the response data for the plurality of predetermined questions into embedding vectors; and
generating at least one group based on distances between the embedding vectors.

14. The method of claim 13, wherein the extracting of the review keyword associated with the product based on the at least one piece of response data further comprises:
extracting a representative keyword from each of the at least one group.

15. The method of claim 1, wherein the information for specifying the product is at least one of a predetermined product name, a product number, or a catalog ID associated with the product.

16. The method of claim 1, wherein the review data is collected from a blog and a smart store,
review data associated with a part of the plurality of predetermined questions is collected from the blog, and
review data associated with a remaining part of the plurality of predetermined questions is collected from the smart store.

17. The method of claim 1, wherein the review data associated with the product is review data generated within a predetermined period.

18. The method of claim 1, further comprising:
removing predetermined forbidden words or special characters from the review data associated with the product after collecting the review data associated with the product based on the information for specifying the product.

19. A non-transitory computer-readable recording medium storing instructions for executing the method for extracting a product review keyword according to claim 1 on a computer.

20. A system for extracting a product review keyword, comprising:
a communication module;
a memory; and
at least one processor connected to the memory and configured to execute at least one computer-readable program included in the memory,
wherein the at least one program includes instructions for:
collecting review data associated with a product based on information for specifying the product;
generating at least one piece of response data from at least a part of the review data based on a plurality of predetermined questions using a language model; and
extracting a review keyword associated with the product based on the at least one piece of response data.
